(19) United States
(12) Patent Application Publication
(10) Pub. No.: US 2010/0142522 A1
(43) Pub. Date: Jun. 10, 2010

(54) METHODS AND APPARATUS FOR ADAPTIVE ERROR CORRECTION IN NETWORKS

(76) Inventor: James Gardner, Holmdel, NJ (US)

Correspondence Address: AT&T Legal Department - HFZ;ATTN. Patent Docketing, One AT&T Way, Room 2A-207, Bedminstor, NJ, 07921, US

(21) Appl. No.: 12/328,611

(22) Filed: Dec. 4, 2008

(51) Int. Cl. H04L 12/56

(52) U.S. Cl. 370/389

(57) ABSTRACT

Methods and apparatus for adaptive error correction in networks are described. Some example methods to transmit data in a network include generating a first number of redundant data packets from a data file at a first location, wherein any first subset of the generated data packets is sufficient to reconstruct the data file. The example methods further include obtaining a variable representative of network conditions associated with a network configured to carry the data packets to a second location, and transmitting a second subset of the data packets based on the variable, wherein the number of packets of the second subset is at least as large as the first subset.

### FIELD OF THE DISCLOSURE

This disclosure relates generally to connectionless networks and, more particularly, to systems and methods for adaptive error correction for connectionless networks.

### BACKGROUND

Connectionless networks, also known as packet-switched networks, are networks in which each packet includes a header. The header includes, among other things, a destination address. As a result, data may be divided into packets and routed via different paths to independently arrive at the destination address, without a direct connection or special instructions. Connectionless networks also allow delivery with little data overhead relative to networks requiring a direct connection. Service providers generally cannot guarantee against packet loss, packet delay, packet error, packet duplication, out-of-order delivery, or other delivery errors. Such delivery errors can cause loss of performance in a receiving application.

### BRIEF DESCRIPTION OF THE DRAWINGS

FIG. 1 is a diagram of an example connectionless network.

FIG. 2 is a block diagram of an example sender apparatus to transmit a data file over a connectionless network.

FIG. 3 is a flowchart representative of example machine readable instructions that may be executed to transmit a data file over a connectionless network.

FIG. 4 is a flowchart representative of example machine readable instructions that may be executed to generate redundant data packets from a data file.

FIG. 5 is a block diagram of an example receiver apparatus to receive and reconstruct a data file from a number of data packets.

FIG. 6 is a flowchart representative of example machine readable instructions that may be executed to reconstruct a data file from a number of data packets received over a connectionless network.

FIG. 7 is a block diagram of an example processing system 700 that may execute the machine readable instructions of FIGS. 3, 4, and/or 6 to implement the example system 100 of FIG. 1, sender apparatus 200 of FIG. 2, and/or the example receiver apparatus of FIG. 5.

### DETAILED DESCRIPTION

Certain examples are shown in the above-identified figures and described in detail below. In describing these examples, like or identical reference numbers may be used to identify common or similar elements. The figures are not necessarily to scale and certain features and certain views of the figures may be shown exaggerated in scale or in schematic for clarity and/or conciseness. Although the following discloses example methods, apparatus, and articles of manufacture, it should be noted that such methods, apparatus, and articles of manufacture are merely illustrative and should not be considered as limiting. Accordingly, while the following describes example methods, apparatus, and articles of manufacture, the examples are not the only way to implement such methods, apparatus, and articles of manufacture.

The example methods, apparatus, and articles of manufacture disclosed herein utilize an information dispersal methodology and information on present network conditions to transmit a data file to a remote location via a connectionless network, such as a packet-switched network. A transmitting application generates a number of redundant data packets based on a data file, and only a portion of the number of data packets is required to reconstruct the data file. Based on network conditions, the application determines how many data packets to transmit over the network to minimize packet loss or packet delay. A receiving device or application receives at least the minimum number of data packets and reconstructs the data file from the same to enable access to the data within the file.

In some examples, the transmitting application transmits the minimum number of data packets necessary to reconstruct the file when network conditions are ideal or nearly ideal. As network conditions degrade, the transmitting application detects the network conditions and transmits a larger number of data packets based on the probability that one or more data packets will be lost or delayed within the network.

Under ideal conditions, connectionless networks can approach the performance of a private connection. However, under less-than-ideal conditions, packet delay or packet loss can become a problem. Some applications can tolerate one or both of packet delay or loss, and some applications cannot tolerate either packet delay or loss. For example, voice over Internet protocol (VoIP) applications are generally intolerant to packet delay. Present solutions, which attempt to reduce packet delay and/or packet loss, include quality of service (QoS) packet services, packet multicasting, buffering, caching, and Packet Time to Live, all of which operate at the transport level.

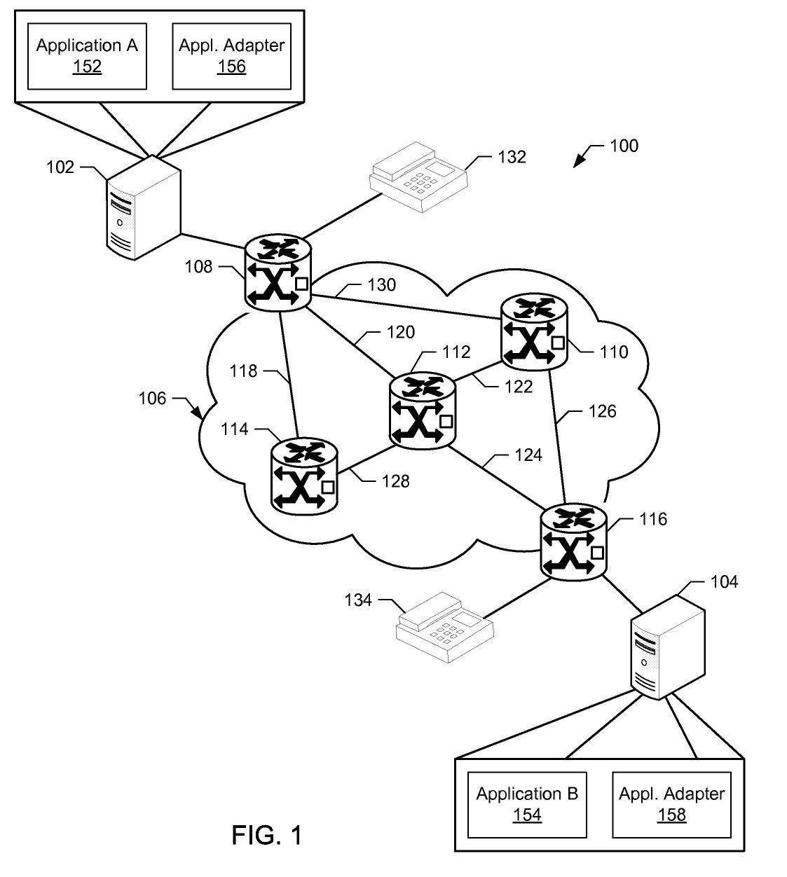

FIG. 1 is a diagram of an example connectionless network 100. The network 100 supports transmission of data between large numbers of computers, servers, IP-based telephones, videoconferencing devices, mobile devices, media devices, and any other data communication devices. Devices organize data into packets for transmission. Transmission of an entire file of data may require one, several, or many packets, depending on the size of the file.

A first computer 102 and a second computer 104 are communicatively coupled to the connectionless network 100. The connectionless network 100 includes a switching network 106 that routes data between switching nodes 108, 110, 112, 114, and 116 over one or more communication paths 118, 120, 122, 124, 126, 128, and 130 connecting the nodes 108-116. The nodes 108-116 provide multiple paths for data to traverse. The use of multiple paths provides load balancing between the nodes 108-116, redundancy in case of a failure of one or more nodes 108-116, and security in the case that an adverse party is monitoring an intermediate node 108-116 or an intermediate path 118-130.

For example, if the first computer 102 transmits two packets of data to the second computer 104, the node 108 may function as an entry node to receive both packets. The node 108 then routes the packets among the nodes 110-116. The packets reach the node 116, which transmits the packets to the second computer 104. The two packets may be routed via the same subsets of the paths 118-130 and nodes 108-116, the same routes, or each packet may reach the node 116 via independent routes. For example, one packet may be routed from the node 108 to the node 112 via the path 120, and then from the node 112 to the node 116 via the path 124. The second packet may be routed from the node 108 to the node 110 via the path 130, and then from the node 110 to the node 116 via the path 126. While routing the packets from the first computer 102 to the second computer 104, the nodes 108-116 are also routing many other packets between many additional computers, servers, and devices, which are not shown.

Although for purposes of discussion, certain nodes 108-116 and paths 118-130 are illustrated in the example network 100, typical large-scale networks include many more (for example, millions) nodes and paths through which data may be routed. In such cases, one or more routes may be unavailable due to failure of a node 108-116 or a path 118-130. To avoid delaying or losing data packets, the nodes 108-116 are connected by multiple paths 118-130 to thereby provide redundancy. For example, if the path 120 is unavailable, a data packet may still be routed from the node 108 to the node 112 via the node 114 and the paths 118 and 128, and/or via the node 110 and the paths 122 and 130. Thus, transport capacity and/or transport speed, also referred to as network conditions, on the network 100 may vary depending on the number of nodes 108-116 or paths 118-130 that are unavailable at any given time.

The example computer 102 executes applications that may communicate with other computers, servers, and/or devices over the network 100. Some applications are particularly sensitive to sending and/or receiving data in a timely fashion. Voice over Internet protocol (VoIP) applications and video conferencing applications, for example, suffer poor performance when packets are delayed or dropped during transport. Other devices, such as VoIP telephones 132 and 134, may also host applications that require timely transportation of data packets on the network 100.

To increase the performance of these applications, the example computers 102 and 104 include an application to adapt the transmission of data to network conditions. For example, a first application A 152 executed by the first computer 102 is to transmit a delay and/or loss-sensitive data file to a second application B 154 executed by the second computer 104. The first application A 152 sends the file to an application adapter 156, which prepares the file for transmission and determines transport conditions on the network 100. The application adapter 156 generates a number n of data slices based on the data in the file. The data slices are generated to be redundant. In other words, a number m of data slices is sufficient to reconstruct the entire data file, and the number n of data slices is greater than m.

The application adapter 156 may generate the n slices from the data file based on the Rabin algorithm. The Rabin algorithm is an information dispersal algorithm that creates n pieces of data (Fᵢ) from a data file (F), which has a length N=|F|. Each piece of data Fᵢ for 1≦i≦n has a length |Fᵢ|=N/m, wherein m pieces of data Fᵢ suffice to reconstruct the file F. Therefore, generating n pieces of data Fᵢ results in a sum of data of (n/m)·N. An in-depth analysis of the Rabin algorithm is provided in “Efficient Dispersal of Information for Security, Load Balancing, and Fault Tolerance,” by Michael O. Rabin, Journal of the Association for Computing Machinery. Vol. 36, No. 2, April 1989. pp. 335-348, the entirety of which is hereby incorporated by reference.

At regular or irregular intervals, or by request, the application adapter 156 receives the network conditions for the network 100. If the network conditions are ideal or substantially ideal, the application adapter 156 determines that a minimum number “m” of data pieces Fᵢ may be transmitted by the application A 152 to adequately transmit the file F to the application B 154 without a significant probability of packet loss or delay. However, if the network conditions are less than ideal, the application adapter 156 determines the probabilities that one or more data pieces Fᵢ will be lost and/or delayed. Based on the probabilities, the application adapter 156 increases the number of data pieces Fᵢ to be sent by the application A 152 to a value “n,” which creates a sufficient probability that the application B 154 will timely receive at least m data pieces Fᵢ. The second computer 104 also includes an application adapter 158, which receives the data pieces Fᵢ from the first computer 102, reconstructs the data file F, and provides the data file F to the application B 154 for use. Both application adapters 156 and 158 may include the capability to generate the n data packets F₁, . . . , Fₙ for transmission from a data file F and to reconstruct the data file F from at least m data packets Fᵢ.

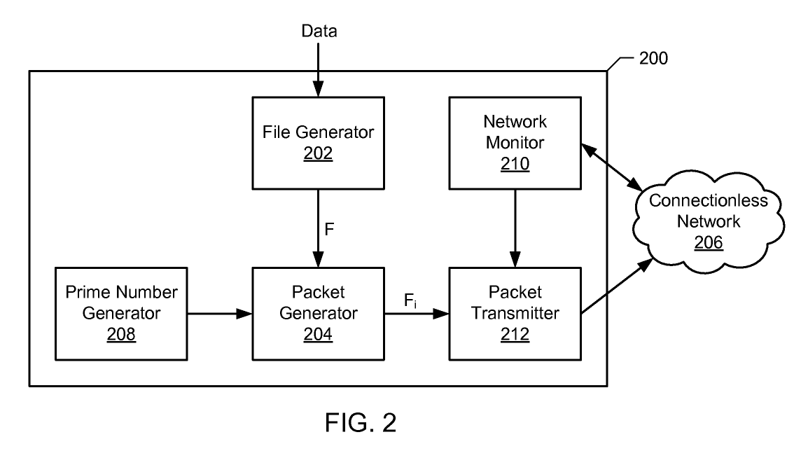

FIG. 2 is a block diagram of an example sender apparatus 200 to transmit a file over a connectionless network. The example sender apparatus 200 generates several packets of data based on a file, determines network conditions between the sender apparatus 200 and the file destination, and adjusts a number “x” of packets to transmit based on the current network conditions. For example, the sender apparatus 200 may implement a hardware and/or software application in the first computer 102 of FIG. 1 to send a data file to the second computer 104 of FIG. 1. For instance, the sender apparatus 200 may be implemented by a processor configured to run the application A 152 and the application adapter 156 of FIG. 1. The number x of data packets transmitted is at least the minimum number m of data packets needed to reconstruct the data file and is at most the total number n of generated redundant data packets.

The example sender apparatus 200 includes a file generator 202 and a packet generator 204. The file generator 202 generates a data file F representative of data to be transmitted to a receiving device over a connectionless network 206. The example data is received from an application, and the data file F may represent, for example, voice communications, audio/video, text, and/or any other type of data that may be transmitted via the connectionless network 206. The file generator 202 may be any type of application to communicate via the connectionless network 206, such as a VoIP application, a web browser, a multimedia application, a video game, and/or any other applications that may communicate via the connectionless network 206.

The packet generator 204 receives the data file F from the file generator 202 and prepares the data file F for transmission. Specifically, the packet generator 204 generates a number n of redundant data packets Fᵢ from the data file F, wherein any subset m of those data packets Fᵢ, . . . , Fₘ may be used to reconstruct the data file F. The numbers n and m may be modified based on network conditions and/or the size of the data file F. The total number n of generated data packets Fᵢ must be greater than the minimum number m of data packets Fᵢ required to reconstruct the data file F. Preferably, n approaches m, where network conditions allow. In some examples, the numbers n and m are determined based on nominal network conditions, such as average network performance and/or service level agreements. In other examples, the numbers n and m are determined based on dynamic network conditions, including file sizes, current network performance, predicted network performance, and/or any other dynamic factors that may indicate a useful level of redundancy. However, basing the numbers n and m on dynamic network conditions is generally more complex than basing the numbers n and m on nominal network conditions.

As described in the Rabin algorithm, the data file F is a series of bits, which can also be considered a series of characters or integers having values taken from a specific range [0 . . . B]. For example, if the data file F is split up into eight-bit bytes, the range of possible values for each byte is [0 . . . 255]. The data file F may be split into any character or integer length, and the upper limit of the range of possible values is B. The packet generator 204 uses a prime number greater than at least B. Therefore, if eight-bit bytes are used to divide the data file, the smallest prime number that may be used is 257. A prime number generator 208 generates a prime number for use by the packet generator 204 in generating the data packets F₁, . . . , Fₙ. The packet generator 204 performs calculations on the data file F based on the prime number received from the prime number generator 208. For example, if the prime number generator 208 generates a prime number 257, the packet generator 204 performs calculations modulo 257.

The example sender apparatus 200 further includes a network monitor 210 to monitor network conditions on the connectionless network 206. Network conditions can include expected packet delay and/or packet loss rate. The network monitor 210 determines the network conditions and provides them to a packet transmitter 212 to determine a number of data packets Fᵢ to transmit to a receiving device over the connectionless network 206. The packet transmitter 212 receives the n data packets F₁, . . . , Fₙ from the packet generator 204, receives the network conditions from the network monitor 210, and determines a number of data packets Fᵢ to transmit based on the network conditions. The example packet transmitter 212 must transmit at least m data packets Fᵢ to enable a receiving device to reconstruct the data.

Under ideal or substantially ideal network conditions, there is a negligible chance of packet loss and/or delay. Therefore, the packet transmitter 212 may transmit the minimum m data packets Fᵢ. However, if the network monitor 210 determines that network conditions may cause some level of packet delay or loss, the packet transmitter 212 increases the number x (where m≦x≦n) of data packets Fᵢ transmitted over the connectionless network by an amount sufficient to ensure that the entire data file F will be received and reconstructed by a receiving device in a timely manner.

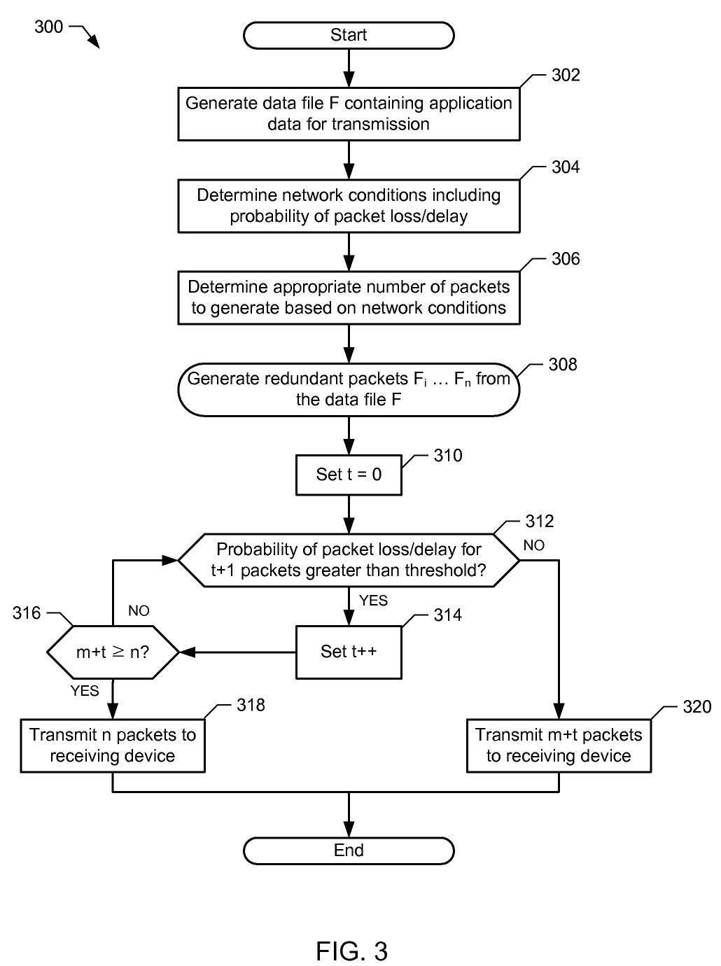

FIG. 3 is a flowchart representative of example machine readable instructions 300 that may be executed to transmit a data file over a connectionless network. The example instructions 300 may be implemented by the example first computer 102 or the example VoIP phone 132 of FIG. 1, and/or by the example sender apparatus 200 of FIG. 2.

The example instructions 300 begin with an application generating a data file F containing data for transmission to a receiving device (block 302). For example, the application A 152 of FIG. 1 may generate a data file F for use by the application B 154. Additionally or alternatively, the example file generator 202 of FIG. 2 may generate the data file F. Prior to transmission of the data file F the network monitor 208 determines network conditions on the connectionless network 206 (block 304). Network conditions may include current, historic, and/or predicted packet loss and/or delay statistics for the network 206 as a whole or for paths between the sending and receiving devices. The network conditions may be for a particular time period, such as the previous 15 minutes, a running average for the previous 24 hours, and/or for any other statistically useful time periods.

Based on the determined network conditions (block 304), the example packet generator 204 determines an appropriate number n of data packets Fᵢ to generate (block 306). In the illustrated example, the appropriate number n is based on the size of the data file F, the network conditions, minimum or maximum data packet size, and/or any other packet constraints. The example packet generator 204 then generates n redundant data packets F₁, . . . Fₙ from the data file F, wherein any m (m≦n) data packets Fᵢ are sufficient to reconstruct the data file F (block 308). The size of each redundant data packet F₁, . . . Fₙ is based on the minimum number m of data packets Fᵢ required to reconstruct the data file F.

After the n data packets F₁, . . . Fₙ are generated (block 308), the example packet transmitter 212 determines the appropriate number x of data packets Fᵢ to transmit to the receiver. Blocks 310-320 illustrate example instructions to determine the appropriate number x of data packets Fᵢ for transmission to increase the chances of timely reception of the data file F at a receiving device. The example packet transmitter 212 sets a variable t equal to zero (block 310). Based on the variable t, the packet transmitter 212 then determines if the probability that t+1 data packets Fᵢ will be delayed or lost during transmission over the connectionless network 206 is greater than a threshold (block 312). The threshold may be chosen to be equal to a tolerable risk of packet loss and/or delay. If the probability that t+1 packets will be lost or delayed is too great, the probability that an insufficient number of data packets Fᵢ will reach the receiving device is unacceptably high.

If the probability is greater than the threshold (block 312), the packet transmitter 212 determines that more data packets Fᵢ are required, and increments the variable t by one (block 314). The packet transmitter 212 then determines if m+t is greater than or equal to n after incrementing t (block 316). If m+t (i.e., x) is not greater than or equal to n (block 316), control returns to block 312 to determine the probability for the new value oft. If m+t is greater than or equal to n (block 316), the packet transmitter 212 does not need to determine another probability, and transmits all n data packets F₁, . . . Fₙ (block 318).

If, at block 312, the probability of packet loss and/or delay for t+1 packets is greater than the threshold, the example packet transmitter 212 transmits m+t packets (block 320). The instructions 300 may end for the data file F or iterate for another data file.

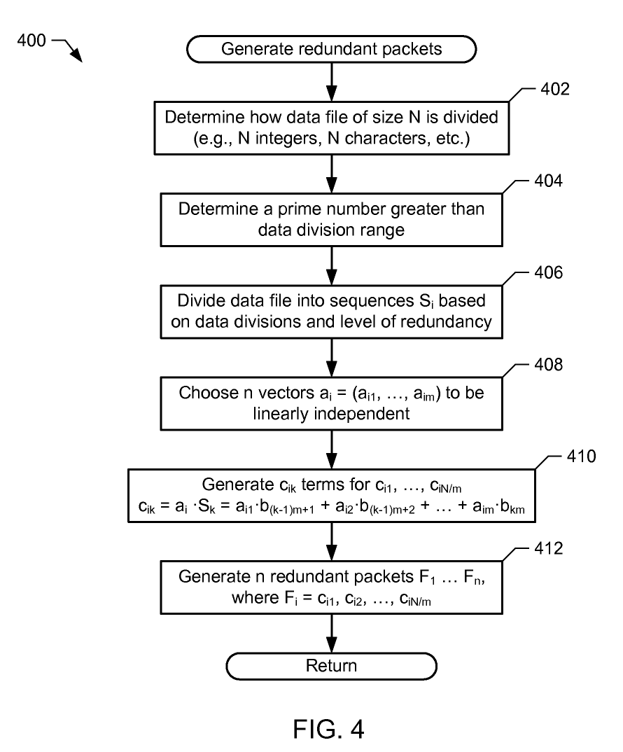

FIG. 4 is a flowchart representative of example machine readable instructions 400 that may be executed to generate redundant data packets Fᵢ from a data file. A detailed explanation of the example instructions 400 is described by Rabin. The example instructions 400 may be executed by the packet generator 204 of FIG. 2 and/or the example block 308 of FIG. 3 to generate redundant packets Fᵢ, . . . Fₙ from a data file F.

The example packet generator 204 begins generating the data packets Fᵢ by determining how a data file F of size N is divided (block 402). For example, the data file F is made up of a series of symbols b₁, b₂, . . . , b_{N}. The symbols b₁, . . . , b_{N} may be considered as bits, integers, doubles, characters, or the like. Further, the size N is modified based on the division unit of bᵢ. This example will use an 8-bit symbol, so each symbol bᵢ has a range of values [0 . . . 255]. The division unit of bᵢ may be predetermined or may conform to the division unit of the application that generated the data file F. A prime number generator 208 generates a prime number that is larger than the largest possible symbol value (block 404). Therefore, the prime number generator 208 in this example must generate a prime number greater than 255, such as 257. The packet generator 204 then uses the generated prime number to generate the data packets F₁, . . . , Fₙ. As described in Rabin, many of the operations performed to generate the data packets are performed modulo p, where p is the generated prime number. Specifically, the symbols b₁, . . . , b_{N} are within the field of residues of modulo p.

The packet generator 204 then divides the data file F into sequences Sᵢ based on the data divisions and the desired level of redundancy (block 406). The level of redundancy may be determined from the appropriate number n of data packets Fᵢ and the minimum number m of data packets Fᵢ determined in block 306 of FIG. 3. Each sequence Sᵢ includes a series of m symbols. For example, S₁ includes b₁, b₂, . . . , bₘ; S₂ includes bₘ₊₁, bₘ₊₂, . . . , b₂ₘ; and so on up to S_{N/m}. When the sequences S₁, . . . , S_{N/m} have been determined, the packet generator 204 chooses a set of n linearly independent vectors aᵢ=aᵢ₁, . . . , aᵢₘ (block 408). As described more thoroughly in Rabin, the linearly independent vectors aᵢ may be chosen randomly.

Based on the n vectors aᵢ and the sequences Sᵢ, the packet generator 204 generates a set of terms cᵢₖ=aᵢ·Sₖ=aᵢ₁·b₍ₖ₋₁₎ₘ₋₁+aᵢ₂·b₍ₖ₋₁₎ₘ₋₂+ . . . +aᵢₘ·bₖₘ (block 410). The packet generator 204 then constructs the redundant data packets F₁, . . . , Fₙ from the terms cᵢₖ, such that Fᵢ=cᵢ₁, cᵢ₂, . . . c_{iN/m} (block 412). The length of each data packet Fᵢ is |F|/m. Therefore, the transmission of the minimum number m of data packets Fᵢ is no more bandwidth-intensive than transmission of a data file F using traditional packet construction techniques. As described in Rabin, the data packets Fᵢ may include the appropriate vectors aᵢ for use by a receiving device in reconstructing the data file F using a particular packet Fᵢ. The data packets Fᵢ may also include digital fingerprints to enable detection of a bad data packet Fᵢ.

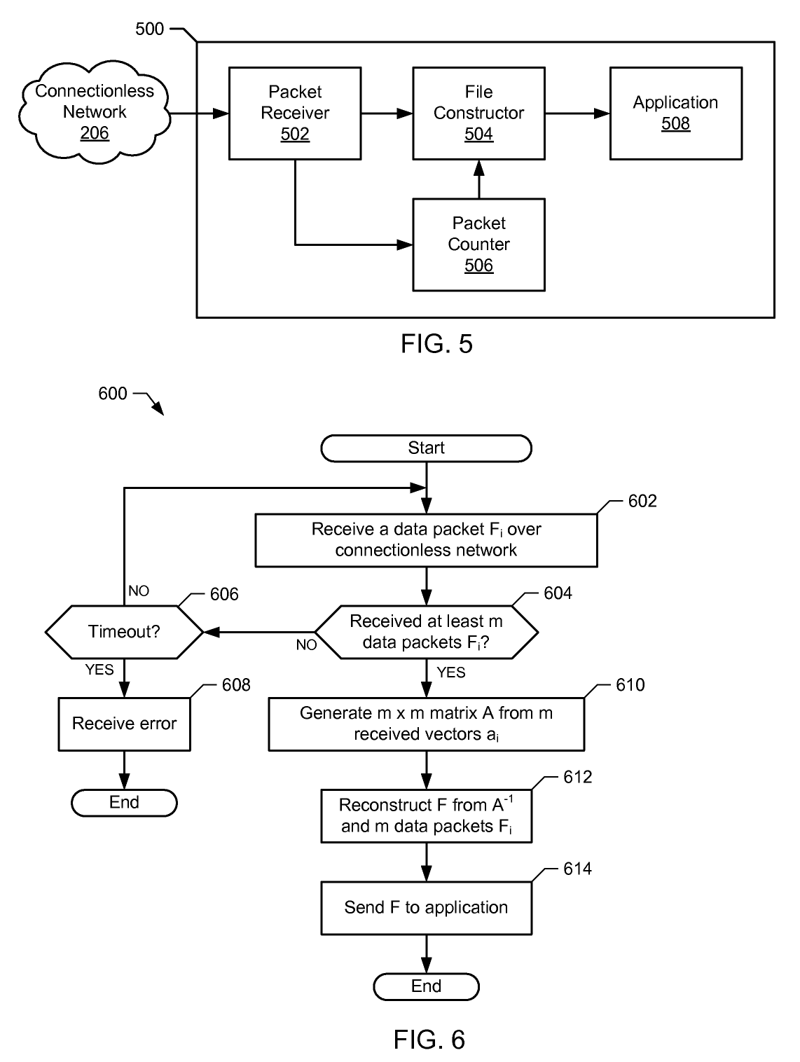

FIG. 5 is a block diagram of an example receiver 500 to receive and reconstruct a data file F from m data packets Fᵢ. The receiver 500 may be implemented via the example second computer 104 illustrated in FIG. 1 to receive a data file F from the example first computer 102. The receiver 500 may also be a VoIP phone receiving voice data while engaged in a conversation with a second VoIP phone. The data file F is constructed using the example sender apparatus 200 of FIG. 2 and/or by executing the example instructions 300 and 400 of FIGS. 3 and 4, respectively.

The example receiver 500 is communicatively coupled to the example sender apparatus 200 of FIG. 2 via the connectionless network 206. The receiver 500 includes a packet receiver 502 to receive incoming data packets Fᵢ from the connectionless network 206. The example packet receiver 502 may be implemented by a traditional network connection used in a network device and configured to forward particular types of data packets to a particular application. Alternatively, the packet receiver 502 may be a network connection monitor configured to identify particular types of data packets Fᵢ from all data packets received at a network device.

When the example packet receiver 502 receives a data packet corresponding to the type of data packets Fᵢ sent by the sender apparatus 200, the packet receiver 502 forwards the data packet Fᵢ to a file constructor 504 and a packet counter 506. The example file constructor 504, after receiving at least m data packets Fᵢ, reconstructs the data file F generated by the example file generator 202 of FIG. 2. An example method of file reconstruction is discussed below in connection with FIG. 6. The example packet counter 506 determines the number of received data packets Fᵢ relative to the number m of data packets Fᵢ necessary to reconstruct the data file F. When the packet counter 506 determines m data packets Fᵢ have been received, the packet counter 506 signals the file constructor 504 to begin reconstruction of the data file F. The packet counter 506 may also determine whether any extra data packets Fᵢ were received. Extra data packets Fᵢ beyond the m data packets Fᵢ may be discarded or, alternatively, used to verify proper reconstruction of the data file F.

After the data file F is reconstructed, the file constructor 504 forwards the data file F to an application 508, which uses the data contained in the data file F. The application 508 may be implemented by, for example, the application B 154 of FIG. 1.

FIG. 6 is a flowchart representative of example machine readable instructions 600 that may be executed to reconstruct a data file F from a number of data packets Fᵢ received over a connectionless network. The example instructions 600 may be executed to implement the example receiver 500 and/or to reconstruct a data file F from at least m data packets Fᵢ received from the sender apparatus 200 of FIG. 2 via the connectionless network 206.

The example instructions 600 begin with the example packet receiver 502 receiving a data packet Fᵢ via the connectionless network 206 (block 602). The data packet Fᵢ is counted by the example packet counter 506, which determines whether at least m data packets Fᵢ have been received (block 604). If fewer than m data packets Fᵢ have been received (block 604), the packet receiver 502 determines whether the receive operation has timed out (block 606). The timeout condition may be used to avoid waiting excessively long for packets, because an excessive number of data packets Fᵢ may have been lost or delayed within the connectionless network 206. If there is no timeout condition present (block 606), control returns to block 602 to wait for more data packets. However, if the receive operation times out (block 606), the packet receiver 502 determines there is a receive error (block 608) and ends the example instructions 600, perhaps after notifying the sending apparatus or a user of the receiver 500 of the error.

If, at block 604, the example packet counter 506 determines that m data packets Fᵢ have been received, the file constructor 504 begins reconstructing the data file F by generating an m×m matrix A from the appropriate vectors aᵢ (block 610). As mentioned above, the vectors aᵢ may be included in the received data packets Fᵢ. Alternatively, the receiver apparatus 500 may have knowledge of the vectors a₁, . . . , aₙ. The file constructor 504 then reconstructs the data file F according to Equation 1:

$$[ \begin{matrix}{b}_{1} \\ ⋮ \\ {b}_{m}\end{matrix} ] = {A}^{- 1} \cdot [ \begin{matrix}{c}_{11} \\ ⋮ \\ {c}_{m 1}\end{matrix} ] \qquad ( Eq . 1 )$$

(block 612). Because Fᵢ=cᵢ₁, cᵢ₂, . . . , c_{iN/m}, data packets Fᵢ will provide the N symbols b₁, . . . , b_{N} necessary to completely reconstruct the data file F. After determining the terms b₁, . . . b_{N}, the file constructor 504 sends the data file F to the application 508 (block 614). The example instructions 600 then end, and the receiving apparatus 500 awaits another data file.

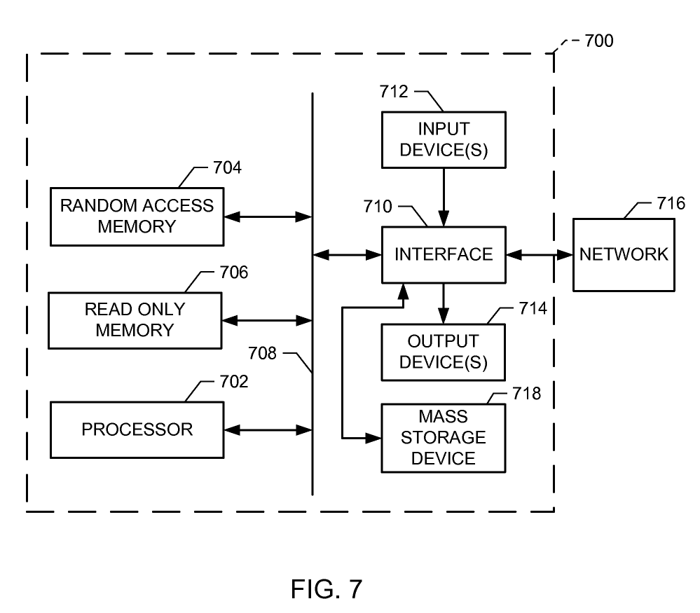

FIG. 7 is a block diagram of an example processing system 700 that may execute the machine readable instructions of FIGS. 3, 4, and/or 6 to implement some or all of the example network 100 of FIG. 1, the example sender apparatus 200 of FIG. 2, and/or the example receiver apparatus of FIG. 5. The processing system 700 can be, for example, a server, a personal computer, a personal digital assistant (PDA), an Internet appliance, a DVD player, a CD player, a digital video recorder, a personal video recorder, a set top box, a VoIP telephone, an analog telephony adapter, or any other type of computing device.

A processor 702 is in communication with a main memory including a volatile memory 704 and a non-volatile memory 706 via a bus 708. The volatile memory 704 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 706 may be implemented by flash memory and/or any other desired type of memory device. Access to the main memory 704, 706 is controlled by a memory controller (not shown).

The processing system 700 also includes an interface circuit 710. The interface circuit 710 may be implemented by any type of interface standard, such as an Ethernet interface, a universal serial bus (USB), and/or a third generation input/output (3GIO) interface.

One or more input devices 712 are connected to the interface circuit 710. The input device(s) 712 permit a user to enter data and commands into the processor 702. The input device(s) can be implemented by, for example, a keyboard, a mouse, a touchscreen, a track-pad, a trackball, isopoint and/or a voice recognition system.

One or more output devices 714 are also connected to the interface circuit 710. The output devices 714 can be implemented, for example, by display devices, such as a liquid crystal display, a cathode ray tube display (CRT), a printer and/or speakers. The interface circuit 710, thus, typically includes a graphics driver card.

The interface circuit 710 also includes a communication device such as a modem or network interface card to facilitate exchange of data with external computers via a network 716, such as an Ethernet connection, a digital subscriber line (DSL), a telephone line, coaxial cable, a cellular telephone system or any other network interface. The network 716 may be implemented via the connectionless networks 106 of FIG. 1 and/or 206 of FIG. 2.

The processing system 700 also includes one or more mass storage devices 718 for storing software and data. Examples of such mass storage devices 718 include floppy disk drives, hard drive disks, compact disk drives and digital versatile disk (DVD) drives.

As an alternative to implementing the methods and/or apparatus described herein in a system such as the device of FIG. 7, the methods and/or apparatus described herein may alternatively be embedded in a structure such as processor and/or an ASIC (application specific integrated circuit).

At least some of the above described example methods and/or apparatus are implemented by one or more software and/or firmware programs running on a computer processor. However, dedicated hardware implementations including, but not limited to, application specific integrated circuits, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein may be stored on a tangible storage medium, such as: a magnetic medium, such as a magnetic disk or tape; a magneto-optical or optical medium such as an optical disk; or a solid state medium such as a memory card or other package that houses one or more read-only (non-volatile) memories, random access memories, or other re-writable (volatile) memories, or successor storage media to any of the above.

Although this patent discloses example systems including software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the above specification described example systems, methods and articles of manufacture, these examples are not the only way to implement such systems, methods and articles of manufacture. Therefore, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method to transmit data in a network, comprising:
generating a first number of redundant data packets from a data file at a first location, wherein a first subset of the generated data packets may be used to reconstruct the data file;
obtaining a variable representative of network conditions associated with a network configured to carry the data packets to a second location; and
transmitting a second subset of the generated data packets based on the variable, wherein the number of packets of the second subset is greater than or equal to a number of data packets in the first subset.

2. A method as defined in claim 1, wherein the number of packets of the second subset is less than or equal to the first number of generated data packets.

3. A method as defined in claim 1, wherein obtaining the variable representative of the network conditions comprises obtaining at least one of packet loss data or packet delay data.

4. A method as defined in claim 1, wherein transmitting the second subset of data packets comprises determining a number of data packets that are likely to be lost or delayed based on the variable representative of network conditions.

5. A method as defined in claim 1, further comprising determining the first number and the first subset based on at least one of a size of the data file, the network conditions, a minimum data packet size, or a maximum data packet size.

6. A method as defined in claim 1, wherein the second subset of data packets contains a minimum number of data packets plus a number of data packets that are expected to be lost or delayed.

7. A method as defined in claim 1, wherein the network conditions comprise at least one of historical network conditions, current network conditions, or predicted network conditions.

8. An apparatus to transmit data in a network, comprising:
a packet generator to generate a first number of redundant data packets from a data file at a first location, wherein a first subset of the generated data packets are sufficient to reconstruct the data file;
a network monitor to obtain a variable representative of network conditions associated with a network configured to carry the data packets to a second location; and
a packet transmitter to transmit a second subset of the generated data packets based on the variable, wherein the second subset is at least as large as the first subset.

9. An apparatus as defined in claim 8, wherein a number of packets of the second subset is less than or equal to the first number of generated data packets.

10. An apparatus as defined in claim 8, wherein the variable representative of the network conditions represents at least one of packet loss data or packet delay data.

11. An apparatus as defined in claim 8, wherein transmitting the second subset of data packets comprises determining a number of data packets that are likely to be lost or delayed based on the variable representative of network conditions.

12. An apparatus as defined in claim 8, wherein the packet generator further determines the first number and the first subset based on at least one of a size of the data file, the network conditions, a minimum data packet size, or a maximum data packet size.

13. An apparatus as defined in claim 8, wherein the second subset of data packets comprises a minimum number of data packets to reconstruct the data file and a buffer number of data packets that are expected to be lost or delayed.

14. An article of manufacture comprising machine readable instructions, which, when executed, cause a machine to:
generate a first number of redundant data packets from a data file at a first location, wherein a first subset of the generated data packets are sufficient to reconstruct the data file;
obtain a variable representative of network conditions associated with a network configured to carry the data packets to a second location; and
transmit a second subset of the generated data packets based on the variable, wherein the second subset is at least as large as the first subset.

15. An article of manufacture as defined in claim 14, wherein the number of packets of the second subset is less than or equal to the first number of generated data packets.

16. An article of manufacture as defined in claim 14, wherein obtaining the variable representative of the network conditions comprises obtaining at least one of packet loss data or packet delay data.

17. An article of manufacture as defined in claim 14, wherein transmitting the second subset of data packets comprises determining a number of data packets that are likely to be lost or delayed based on the variable representative of network conditions.

18. An article of manufacture as defined in claim 14, wherein the machine readable instructions further cause the machine to determine the first number and the first subset based on at least one of a size of the data file, the network conditions, a minimum data packet size, or a maximum data packet size.

19. An article of manufacture as defined in claim 14, wherein the network conditions comprise at least one of historical network conditions, current network conditions, or predicted network conditions.

20. An article of manufacture as defined in claim 14, wherein the second subset of data packets comprises the minimum number of data packets to reconstruct the data file and a buffer number of data packets that are expected to be lost or delayed.
